(19) United States
(12) Patent Application Publication
(10) Pub. No.: US 2025/0218433 A1
(43) Pub. Date: Jul. 3, 2025

(54) AUTOMATIC SPEECH RECOGNITION WITH TARGET WORD SPOTTING

(71) Applicant: NVIDIA Corporation, Santa Clara, CA (US)

(72) Inventors: Andrei Andrusenko, Yerevan (AM); Aleksandr Laptev, Yerevan (AM); Vladimir Bataev, Yerevan (AM); Vitaly Lavrukhin, Campbell, CA (US); Boris Ginsburg, Sunnyvale, CA (US)

(21) Appl. No.: 18/616,117

(22) Filed: Mar. 25, 2024

Related U.S. Application Data
(60) Provisional application No. 63/615,010, filed on Dec. 27, 2023.

(51) Int. Cl. G10L 15/183; G10L 15/02; G10L 15/16

(52) U.S. Cl. CPC G10L 15/183; G10L 15/02; G10L 15/16

(57) ABSTRACT

Disclosed are apparatuses, systems, and techniques that may use machine learning for implementing automatic speech recognition (ASR) facilitated with a search for target words. The techniques include applying an ASR model to audio data to generate an ASR output representative of a likelihood that the audio data comprises one or more spoken speech units (SUs), generating, using the ASR output, a first score characterizing a likelihood that the audio data comprises a first word, wherein the first word comprises a dictionary word, generating, using the ASR output, a second score characterizing a likelihood that the audio data comprises a second word, wherein the second word comprises a word of a plurality of target words, wherein the plurality of target words is identified based at least on a context of the audio data, and predicting, using the first score and the second score, a spoken word associated with the audio data.

### RELATED APPLICATIONS

This application claims the benefit of U.S. Provisional Patent Application No. 63/615,010, filed Dec. 27, 2023, entitled “Fast Context-Biasing for CTC and Transducer ASR Models with CTC-based Word Spotter,” the contents of which are incorporated by reference in their entirety herein.

### TECHNICAL FIELD

At least one embodiment pertains to processing resources used to perform and facilitate speech recognition, transcription, and/or diarization. For example, at least one embodiment pertains to systems and techniques that facilitate efficient automated speech recognition assisted with target word spotting.

### BACKGROUND

Speech recognition, also known as automatic speech recognition (ASR) or speech-to-text (STT; S2T), is an intersection of computer technology and linguistics directed to techniques of recognition and translation of spoken language into text. ASR systems often deploy machine-learning models, e.g., trained neural networks, to recognize phonemes, graphemes, words, sentences, and other units of speech. Speaker-independent ASR models rely on general phonetic and semantic characteristics of speech that remain uniform across different speakers. Speaker-dependent ASR models use samples of speech of a particular speaker to fine-tune the models to recognize that person's speech, resulting in increased accuracy of ASR processing.

### BRIEF DESCRIPTION OF DRAWINGS

FIG. 1A is a block diagram of an example computer system capable of performing automatic speech recognition facilitated with a speech unit-based search for target words, according to at least one embodiment;

FIG. 1B illustrates an example computing device that supports training or deployment of an audio processing pipeline capable of performing automatic speech recognition facilitated with a search for target words, according to at least one embodiment;

FIG. 2 illustrates an example architecture and data flow of an audio processing pipeline capable of combining a general search for dictionary words with a dedicated search for target words on the context list, according to at least one embodiment;

FIG. 3 illustrates one example embodiment of automatic speech recognition processing that combines a general search for dictionary words with a search for target words, according to at least one embodiment;

FIG. 4 illustrates an example context graph that may be used for detection of target words for improved accuracy of automatic speech recognition, according to at least one embodiment;

FIG. 5A illustrates one example embodiment of automatic speech recognition that deploys a hybrid transducer-CTC model augmented with a search for target words, according to at least one embodiment;

FIG. 5B illustrates schematically an example processing of a spoken utterance using a hybrid ASR model architecture of FIG. 5A, according to at least one embodiment;

FIG. 6 is a flow diagram of a method of automatic speech recognition that combines a general search for dictionary words with a search for target words, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment; and

FIG. 10 is a system diagram for an example system for training, adapting, instantiating and deploying machine learning models in an advanced computing pipeline, according to at least one embodiment.

### DETAILED DESCRIPTION

ASR models perform better when recognizing words that have been encountered in multiple instances of training data. On the other hand, words that have not been represented or had few examples in the training data are often recognized poorly. To improve ASR results, a list of words and phrases likely to be encountered in a particular speech context can be composed-known as context-biasing—and used in training of the ASR models. For example, deep fusion context-biasing integrates such context lists into the training process of the models, e.g., by representing the context words via model-readable embeddings and encoding associations between spoken sounds and the context words via a cross-attention mechanism. In shallow-fusion context biasing, the context words are provided to a decoder portion of an ASR model. In some instances, the final selection of multiple hypotheses may be performed using probabilities generated by the ASR decoder, e.g., while performing a beam search across the hypotheses, but with additional weights given to words that appear to resemble the words on the context list. In some techniques, the list of context words may be included in a prompt of a language model (LM) trained to process and finalize the ASR outputs.

Such techniques, however, typically require processing of many alternative hypotheses and thus lead to a significant slowdown of ASR, which is especially problematic in the instances of live transcriptions and dialogues. In some ASR models, this problem is especially acute. For example, a recurrent neural network transducer (RNNT) model deploys a beam search decoding that involves multiple decoder (prediction and joint network) calculations. Moreover, the context-biasing recognition is limited to initial predictions of an ASR model. Consequently, in the instances of rare or new words, an ASR model may simply not generate any hypothesis for the words that are included in the context-biasing list. As a result, the list may not be effective in recognition of the target words.

Aspects and embodiments of the present disclosure address these and other challenges of the ASR technology by providing for techniques and systems that combine general search for dictionary words-conducted using an output of a trained ASR model—with a dedicated unit-based search for target words on the context list. In various embodiments, the units (tokens) identified by an ASR model may include graphemes (e.g., single-character units of transcribed speech), subwords (e.g., single- or multi-character portions of words), phonemes (e.g., sounds associated with various letters and their combinations), and/or any other suitable units of speech that identify a content of speech. For example, an ASR model may process a time sequence of audio data (e.g., mel-spectrograms of a particular speech episode) and generate probabilities pⱼ of various units of a language being spoken within consecutive intervals of a set duration t (e.g., 0.25 sec, 0.5 sec, and/or the like). A target-word spotter may be looking out for an onset of any spoken target word from the list at any of the time intervals τ₁, τ₂, . . . . The target words from the context list may be represented via a context graph (trie). The context graph may include multiple branches corresponding to a sequence of units of respective target words. Root nodes of the context graph may be associated with starting units of a target word. The context graph may also have blank nodes to modulate an empty unit according to a suitable transition topology, including but not limited to connectionist temporal classification (CTC) transition rules. For example, if the list of the target words includes “GPU,” “NVIDIA,” “GeForce,” “CUDA,” and/or the like, the target-word spotter may look for probabilities (generated by the ASR model) that speech units (tokens) “G,” “N,” and “C” (as encountered at the beginning of the corresponding spoken words) are detected at a particular time interval 11 and eliminate from consideration those units whose probability is low. In one example embodiment, a hypothesis (about a prospective unit) with the highest probability pₘₐₓ may be identified and a difference between pₘₐₓ and a certain (empirically set) threshold probability p₀ may be computed to obtain a minimum probability pₘᵢₙ=pₘₐₓ−p₀. The target-word spotter may then evaluate the remaining candidate units and discard those candidates whose probability is below pₘᵢₙ. For example, if it is determined that the probability of units “G,” “N,” and “C” being pronounced (at the time interval τ₁) are p_{G}=0.5, p_{N}=0.1, p_{C}=0.35 while the threshold probability is p₀=0.2 and, correspondingly, pₘᵢₙ=0.5−0.2=0.3, the target-word spotter may begin tracking the probability that one of words “GPU,” “GeForce,” or “CUDA” is being pronounced, while assuming that word “NVIDIA” is not currently being spoken. (The target-word spotter may still watch for a possibility that these words—or some other target words—may be pronounced starting from one of the subsequent time intervals τ₂, τ₃, etc.).

Having detected unit “G,” the target-word spotter may initialize processing along graph branches associated with words “G-P-U” and “G-E-F-O-R-C-E” (in the instances of a grapheme-based tokenizer) or “G-E-FOR-CE” (in the instance of a subword-based tokenizer or a grapheme-based tokenizer) where each letter or a combination of letters indicates a node of a graph and each hyphen stands for an edge connecting the nodes. The branches may be joined at the root node “G” and diverge afterwards. As the target-word spotter proceeds along the edges of the graph, the target-word spotter makes additional steps along the graph based on the probabilities (or other likelihoods) generated by the ASR model for the subsequent time intervals τ₂, τ₃, etc. For example, during time interval τ₂, the ASR may have determined that speech unit “P” is being spoken with probability pₚ (indicative of a likelihood that the word “GPU” is being spoken), speech unit “E” is being spoken with probability p_{E} (indicative of a likelihood that the word “GeForce” is being spoken), and/or the like, along with the probabilities that various other speech units are being pronounced during interval τ₂, e.g., indicative that some other word (a dictionary word or some other word on the target list) is being spoken. Additionally, the target-word search may evaluate probabilities that pronunciation of speech unit “P” has continued into interval τ₂ or that a pause (no detectable unit of speech) has occurred, in which instances the target-word spotter may dwell on the last node(s) of the graph. The target-word spotter may proceed through the graph for additional time intervals τ₃, τ₄, etc., until one of the target words (e.g., “GPU”) is identified or until subsequent probabilities generated by the ASR model indicate that neither word associated with the graph (e.g., “GPU-GeForce” graph) is being spoken, in which case the walk down the graph may be abandoned.

In some embodiments, a single working hypothesis, e.g., the highest probability hypotheses, may be maintained at each time interval. For example, if at node “G” (e.g., at time interval τ₂) the probability of unit “P” being spoken is p_{P}=0.55 and the probability of the unit “E” being spoken is p_{E}=0.37, the target-word spotter may follow the “G-P-U” branch of the graph and abandon the “G-E-FOR-CE” branch. In some embodiments, multiple working hypotheses may be maintained. In the above example, both branches may be followed until one or more additional speech units are encountered. For example, if the next unit (pronounced at time interval τ₃) is “U” with probability p_{U}=0.68 or “FOR” with probability p_{FOR}=0.29, the probability of the “G-E-FOR-CE” branch (0.37×0.29=0.11) may be determined to be too small compared to the probability of the “G-P-U” branch (0.55×0.68=0.37), and the “G-E-FOR-CE” branch may be abandoned. In some embodiments, transitions to the next node in the graph may be given additional weights in comparison with dwelling on the last node of the graph, to enhance the likelihood of detecting target words. Such additional weights may be empirically selected, based on experimentally determined degree to which recognition of target words is to be favored over detection of dictionary words or over detection of non-speech time intervals (blanks).

At the end of such graph processing, the target-word spotter may return a score S_{WS} for the most likely word spoken within a time T that spans the series of time intervals T={τ₁ . . . τ_{N}}. In the instances where the target-word spotter detects multiple candidate target words within the same time (or overlapping times), a candidate word having the maximum score S_{WS} (e.g., a multiplication product of various unit probabilities or a sum of log-probabilities, suitably modified with additional weights), may be selected. The candidate word having the maximum score (likelihood) may then be compared to a score for a particular word (or multiple words) spoken during the same time T determined using a general (dictionary) word search.

The higher-likelihood word may than be selected as the final word. For example, if the target-word spotter determines that the word “NVIDIA” was spoken with the 0.74 probability and the dictionary search has determined that the word “video” was spoken with the 0.65 probability, the word “NVIDIA” may be selected as the final word. More specifically, the dictionary word search may be performed using one or more techniques. For example, the ASR model may include a backbone encoder network and one or more decoder networks, e.g., CTC decoder, a recurrent neural network transducer (RNNT) decoder, and/or the like. In some embodiments, a candidate dictionary word may be identified using the same set of probabilities (e.g., as generated by the CTC decoder) of various speech units spoken during time T, as was used in the word-spotter search. A CTC greedy (or similar) algorithm may identify the most likely word (or multiple words) spoken during the same time T together with the likelihood (score) of such a word S_{CTC}. For example, a multiplication product of individual CTC probabilities or a sum of log-probabilities may be computed. The score of the target word (as identified by the word-spotter) S_{WS} and the score of the dictionary word S_{CTC} (as identified by the CTC greedy algorithm) may then be compared for the same time T and the higher-scored word may be selected. In some embodiments, one or more additional decoders may be available, which may output separate predictions of spoken words. In some instances, such decoders (e.g., RNNT decoder) may be more accurate than the decoder that outputs individual speech unit probabilities (e.g., the CTC decoder). In such instances, a word identified using a comparison of the S_{CTC} and S_{WS} scores may replace a word (or multiple words) predicted for the corresponding time T by a more accurate decoder. For other times, where no target word was predicted by the target-word spotter, the words predicted by the more accurate decoder may be selected as the final predicted words.

The advantages of the disclosed techniques include, but are not limited to, fast and economical detection of words that are available via a target (context-biasing) list but have not been widely represented in the training data used to train the ASR model(s). The detection of target words is performed using the unmodified ASR output as part of algorithmic post-ASR processing of the output likelihoods of various units. The additional processing time is minimal and scales approximately linearly with the size (number of words) of the target list. This is advantageous compared with the attention-based deep fusion, which scales quadratically with the size of the list and requires a large number of neural network computations to generate and process multiple cross-attention scores for the various words on the target list. Additionally, the disclosed techniques combine fast spotting of the target words with fast greedy decoding of dictionary words that are not on the context-biasing list of the target words. As a result, the disclosed techniques operate much faster than beam-search decoding techniques deployed in shallow-fusion methods.

### System Architecture

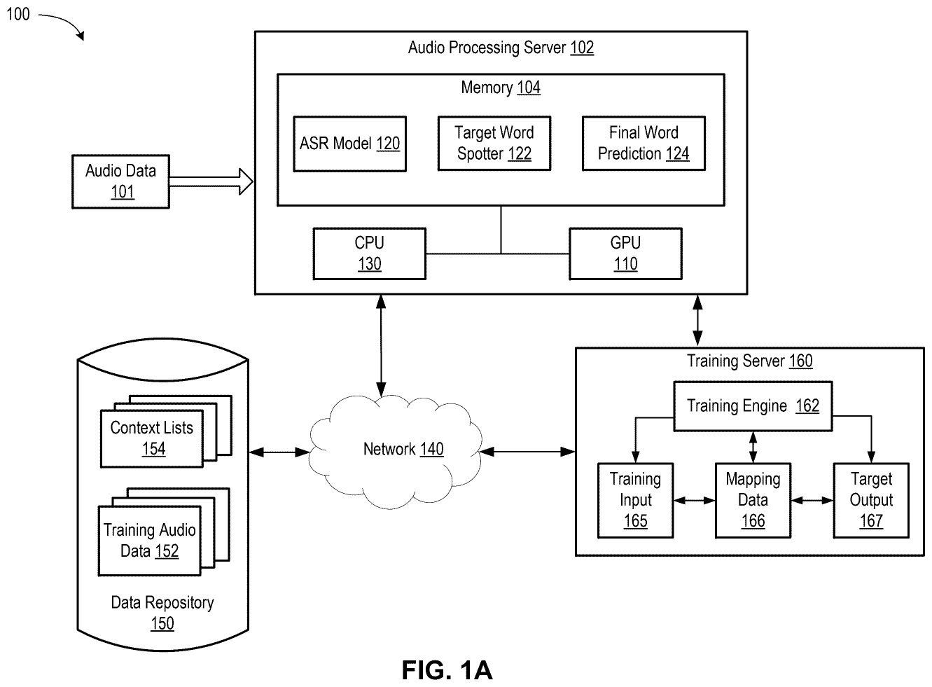

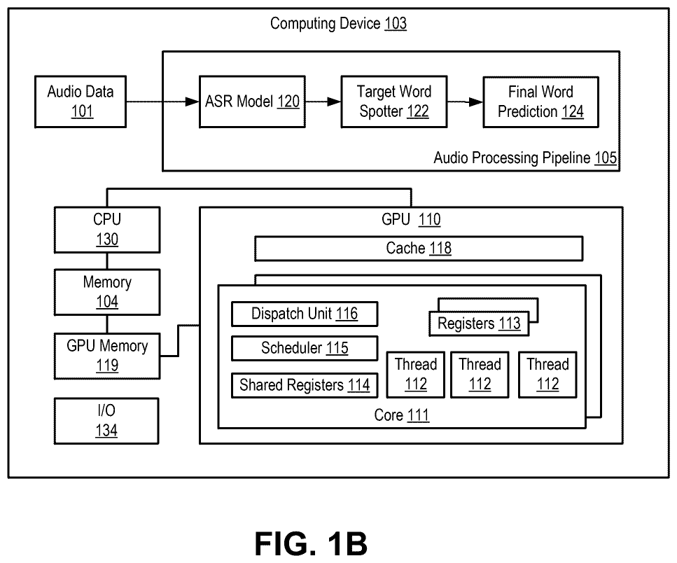

FIG. 1A is a block diagram of an example computer system 100 capable of performing automatic speech recognition facilitated with a speech unit-based search for target words, in accordance with at least some embodiments. As depicted in FIG. 1A, a computing system 100 may include an audio processing server 102, a data repository 150, and a training server 160 connected to a network 140. Network 140 may be a public network (e.g., the Internet), a private network (e.g., a local area network (LAN), or wide area network (WAN)), a wireless network, a personal area network (PAN), a combination thereof, and/or another network type.

Audio processing server 102 may include a desktop computer, a laptop computer, a smartphone, a tablet computer, a server, a wearable device, a VR/AR/MR headset or head-up display, a digital avatar or chatbot kiosk, an in-vehicle infotainment computing device, and/or any suitable computing device capable of performing the techniques described herein. Audio processing server 102 may be configured to receive audio data 101 that may be associated with any speech episode involving one or more speakers. Speech episodes may include a public or private conversation, a business meeting, a public or private presentation, an artistic event, a debate, an interaction between a digital agent (e.g., chat bot, digital avatar, etc.) and one or more users, an in-vehicle communication (e.g., between two or more occupants, between an occupant(s) and a chat bot, avatar, or digital assistant of the vehicle), and/or the like. Audio data 101 may be recorded using one or more devices connected to audio processing server 102, retrieved from memory 104 of audio processing server 102, and/or received over any local or network connection (e.g., via network 140) from an external computing device. Audio data 101 may be in any suitable format, e.g., WAV, AIFF, MP3, AAC, WMA, or any other compressed or uncompressed audio format. In some embodiments, audio data 101 may be stored (e.g., together with other data, such as metadata) in data repository 150. Additionally, data repository 150 may store training audio data 152 for training one or more machine learning models, e.g., ASR model 120. Data repository 150 may be accessed by audio processing server 102 directly or (as shown in FIG. 1A) via network 140.

Data repository 150 may include a persistent storage capable of storing audio files as well as metadata for the stored audio files. Data repository 150 may be hosted by one or more storage devices, such as main memory, magnetic or optical storage disks, tapes, or hard drives, network-attached storage (NAS), storage area network (SAN), and so forth. Although depicted as separate from audio processing server 102, in at least some embodiments, data repository 150 may be a part of audio processing server 102. In at least some embodiments, data repository 150 may be a network-attached file server, while in other embodiments data repository 150 may be some other type of persistent storage such as an object-oriented database, a relational database, and so forth, that may be hosted by a server machine or one or more different machines coupled to the audio processing server 102 via network 140.

Audio processing server 102 may include a memory 104 (e.g., one or more memory devices or units) communicatively coupled with one or more processing devices, such as one or more graphics processing units (GPU) 110, one or more central processing units (CPU) 130, one or more data processing units (DPU), one or more parallel processing units (PPUs), and/or other processing devices (e.g., field-programmable gate arrays (FPGAs), application-specific integrated circuits (ASICs), and/or the like). Memory 104 may store one or more components and models, such ASR model 120 capable of recognizing sounds captured by audio data 101 as perceptively distinct speech units (tokens) and various words and sentences made of those speech units. Memory 104 may store a target-word spotter 122 capable of combining identified SUs into sequences that correspond to words identified via various context lists 154 as words associated with specific topics, subjects, specialized fields of knowledge, interests, and/or the like. Memory 104 may also include a final word prediction 124 module that selects from various competing predictions made by ASR model 120 and target-word spotter 122 and determine the most likely spoken word, e.g., selecting from a common dictionary word “video” (predicted by ASR model 120) and word “NVIDIA” from a context list (predicted by target-word spotter 122).

Training audio data 152 may be stored in a data repository in a raw audio format, e.g., in the form of spectrograms, or in any other suitable representation characterizing speech (e.g., of a particular person). For example, a spectrogram of training audio data 152 may be obtained by recording air pressure caused by the speech as a function of time and computing a short-time Fourier transform for overlapping time intervals (frames) of a set duration. This maps the audio signal from the time domain to the frequency domain and generates a spectrogram characterizing the spectral content of training audio data 152. The amplitude of the audio signal may be represented on a logarithmic (decibel) scale. In some embodiments, the obtained spectrograms may be further converted into mel-spectrograms, by transforming frequency f into a non-linear mel domain, f→m=a ln(1+f/b), to take into account the ability of a human car to better distinguish between equally spaced frequencies (tones) at the lower end of the frequencies of the audible spectrum than at its higher end. In one example, a=1607 and b=700 Hz. Throughout this disclosure, the term “speech spectrogram” may be understood to include Fourier spectrograms or mel-spectrograms, where applicable.

In at least one embodiment, ASR model 120 may be implemented as a deep learning neural network having multiple levels of linear or non-linear operations. For example, ASR model 120 may include convolutional neural networks, recurrent neural networks, fully-connected neural networks, long short-term memory (LSTM) neural networks, neural networks with attention, e.g., transformer neural networks, and/or the like. In at least one embodiment, ASR model 120 may include multiple neurons, an individual neuron receiving its input from other neurons and/or from an external source and producing an output by applying an activation function to the sum of inputs modified by (trainable) weights and a bias value. In at least one embodiment, ASR model 120 may include multiple neurons arranged in layers, including an input layer, one or more hidden layers, and/or an output layer. Neurons from adjacent layers may be connected by weighted edges. In some embodiments, training server 160 may train a number of different models, which may be models that differ by a number of neurons, number of neuron layers, specific neural architecture, and/or the like.

Training audio data 152 may be used by a training server 160 to identify parameters (e.g., neural weights, biases, parameters of activation functions, etc.) of ASR model 120 that maximize success of speaker identification, verification, and/or diarization. Training server 160 may be hosted by a desktop computer, a laptop computer, a smartphone, a tablet computer, a server, and/or any suitable computing device capable of performing the techniques described herein. In some embodiments, training of ASR model 120 may be supervised, e.g., using human-annotations of training audio data 152 with speaker identities as ground truth, or may be unsupervised, semi-supervised, and/or include reinforcement learning techniques.

Training audio data 152 may be used by training engine 162 as training input 165 to train ASR model 120 to predict likelihoods of various speech units associated with a particular language being spoken during consecutive time intervals τ₁, τ₂, τ₃, etc. In one example embodiment, an output layer of ASR model 120 may include, for each of N known speech units of the language, a node that outputs a probability that the respective speech unit is spoken during a particular time interval τⱼ. The probabilities p₁, p₂, . . . p_{N} may be normalized, p₁+p₂+ . . . +p_{N}=1. In some embodiments, the output layer of ASR model 120 may output log-probabilities Lₖ=ln pₖ. In some embodiments, training engine 162 may cause execution of ASR model 120 to process training inputs 165 constructed using training audio data 152, which may include various recorded speech utterances. In some embodiments, training engine 162 may use training embeddings, e.g., vectors representative of speech (and non-speech) segments of training inputs 165. During training, training engine 162 may also generate mapping data 166 (e.g., metadata) that associates training inputs 165 with correct target outputs 167 (ground truth). Training may cause ASR model 120 to identify patterns in training inputs 165 based on desired target outputs 167 and learn to accurately identify various spoken phonemes in training inputs 165.

Initially, edge weights and biases (e.g., parameters) of various network models being trained may be assigned some starting (e.g., random) values. For every training input 165, training engine 162 may cause ASR model 120 to generate output(s). Training engine 162 may then compare observed output(s) with the desired target output(s) 167. The resulting error or mismatch, e.g., the difference between the desired target output(s) 167 and the actual output(s) of the neural networks, may be back-propagated through the respective neural networks, and the weights and biases in the neural networks may be adjusted to make the actual outputs closer to the target (ground truth) outputs. This adjustment may be repeated until the output error for a given training input 165 satisfies a predetermined condition (e.g., falls below a predetermined value). Subsequently, a different training input 165 may be selected, a new output generated, and a new series of adjustments implemented, until the respective neural networks are trained to a target degree of accuracy or until the neural network(s) converges to a limit of its accuracy.

Predictive utility of the identified patterns may be subsequently verified using additional training input/target output associations. The trained ASR model 120 and/or other models similarly trained, may be used, during the inference stage, for processing of new (not encountered previously) input speech.

In at least one embodiment, training server 160 and audio processing server 102 may be implemented on a single computing device. Training server 160 and/or audio processing server 102 may be (and/or include) a rackmount server, a router computer, a personal computer, a laptop computer, a tablet computer, a desktop computer, a media center, or any combination thereof.

In some embodiments, for efficient training, dropout techniques may be used for at least some of the training epochs, with outputs of at least some neurons removed (e.g., replaced with zero outputs). This forces the remaining neurons to learn how to perform speech unit/word classification tasks more efficiently and generate more accurate outputs. In the course of training, different neurons (e.g., randomly chosen neurons) may be dropped during processing of different batches of training data, so that all neurons learn to perform tasks more accurately and efficiently.

FIG. 1B illustrates an example computing device 103 that supports training or deployment of an audio processing pipeline capable of performing automatic speech recognition facilitated with a search for target words, according to at least one embodiment. In at least one embodiment, computing device 103 may be a part of audio processing server 102. In at least one embodiment, computing device 103 may be a part of training server 160. In at least one embodiment, computing device 103 supports an audio processing pipeline 105 that includes (but need not be limited to) ASR model 120, target-word spotter 122, final word prediction 124, and/or other modules and components (not explicitly depicted in FIG. 1B) that may be used to process audio data 101. Operations of audio processing pipeline 105 may be executed using one or more GPUs 110, one or more CPUs 130, one or more parallel processing units (PPUs) or accelerators, such as a deep learning accelerator, data processing units (DPUs), and/or the like. In at least one embodiment, a GPU 110 includes multiple cores 111, each core being capable of executing multiple threads 112. Each core may run multiple threads 112 concurrently (e.g., in parallel). In at least one embodiment, threads 112 may have access to registers 113. Registers 113 may be thread-specific registers with access to a register restricted to a respective thread. Additionally, shared registers 114 may be accessed by one or more (e.g., all) threads of the core. In at least one embodiment, each core 111 may include a scheduler 115 to distribute computational tasks and processes among different threads 112 of core 111. A dispatch unit 116 may implement scheduled tasks on appropriate threads using correct private registers 113 and shared registers 114. Computing device 103 may include input/output component(s) 134 to facilitate exchange of information with one or more users or developers.

In at least one embodiment, GPU 110 may have a (high-speed) cache 118, access to which may be shared by multiple cores 111. Furthermore, computing device 103 may include a GPU memory 119 where GPU 110 may store intermediate and/or final results (outputs) of various computations performed by GPU 110. After completion of a particular task, GPU 110 (or CPU 130) may move the output to (main) memory 104. In at least one embodiment, CPU 130 may execute processes that involve serial computational tasks whereas GPU 110 may execute tasks (such as multiplication of inputs of a neural node by weights and adding biases) that are amenable to parallel processing. In at least one embodiment, audio processing pipeline 105 may determine which processes are to be executed on GPU 110 and which processes are to be executed on CPU 130. In other embodiments, CPU 130 may determine which processes are to be executed on GPU 110 and which processes are to be executed on CPU 130.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) (which may process text, voice, image, and/or other data types to generate outputs in one or more formats), systems implemented at least partially using cloud computing resources, systems for performing generative AI operations, and/or other types of systems.

### Audio Processing Pipeline

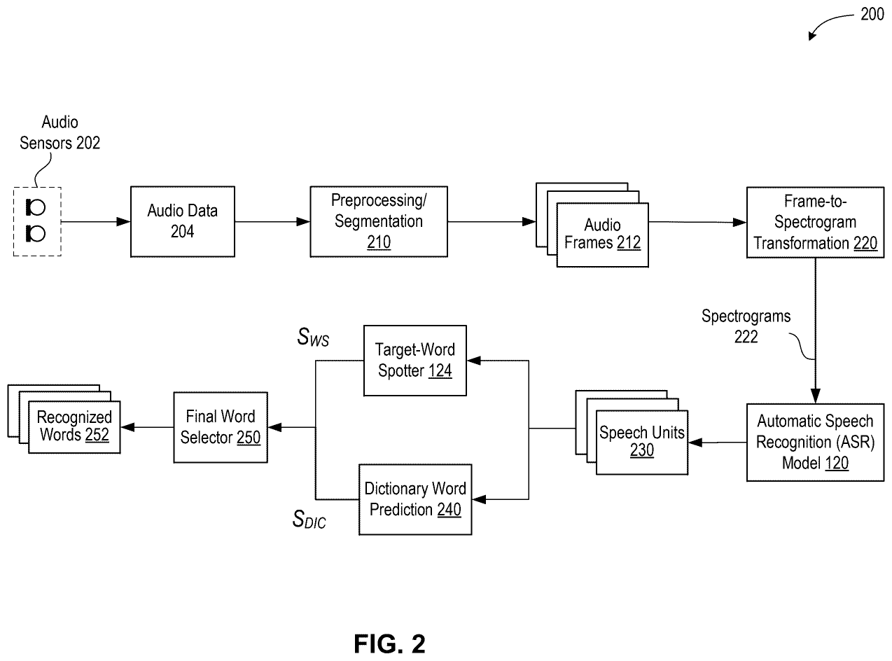

FIG. 2 illustrates an example architecture and data flow of an audio processing pipeline 200 capable of combining a general search for dictionary words with a dedicated search for target words on the context list, according to at least one embodiment. In at least one embodiment, audio processing pipeline 200 may be implemented using audio processing server 102, which may be located on a single computing device or on multiple computing devices. Various blocks in FIG. 2 denoted with the same numerals as the respective blocks of FIG. 1A and/or FIG. 1B may implement the same (or a similar) functionality.

As illustrated in FIG. 2, audio processing pipeline 200 may receive audio data 204 captured by one or more audio sensors 202, e.g., microphones. Microphones can include dynamic microphones, condenser microphones, ribbon microphones, unidirectional microphones, omnidirectional microphones, and/or any other types of microphones. In some embodiments, a microphone can be combined with other devices, e.g., computers, phones, speakers, TV screens, and/or the like. The audio data 204 collected by audio sensors 202 may be generated, e.g., spoken, by a single speaker or multiple speakers and may include a single speech episode or multiple speech episodes. Audio sensors 202 may capture not only a speech signal but also background noise, interference signals, e.g., emitted by TV devices, radio devices, alarm devices, and/or any other equipment, or sounds naturally occurring (e.g., sound of wind, water, birds, etc.).

Audio data 204 collected by audio sensors 202 may undergo speech preprocessing and segmentation 210. For example, preprocessing may include audio filtering, denoising, amplification, dereverberation, and/or any other suitable enhancement. Preprocessing may further include removal of portions of the audio data 204 that do not have a speech content. For example, preprocessing may evaluate energy e(t) associated with the audio data as a function of time and identify regions that have energy less than a certain threshold (e.g., an empirically determined noise threshold). Such identified regions may be removed (trimmed) from the audio data 204 during speech preprocessing. Segmentation may include segmenting the audio data 204 into segments of a predetermined sizes (durations), τ, e.g., 0.5-5 sec. Such segments are sometimes referred to as utterances herein. It should be understood that utterances need not correspond to a complete logical unit of speech and may encompass one or more sentences, one or more words, a part of a word (e.g., subwords), one or more exclamations or other punctuation, filler words, pauses, and/or the like. In some embodiments, the segments may be partially overlapping.

Individual utterances may be represented by a plurality of audio frames 212, e.g., M frames over a certain predetermined interval of time. Audio frames 212 may have a duration of 15 msec, 20 msec, 30 msec, and/or some other duration. Audio frames 212 may undergo a suitable frame-to-spectrogram transformation 220. For example, a spectrogram of a frame may be obtained or generated by performing the discrete Fourier transform of acoustic energy e(t) or air pressure p(t) associated with a specific utterance. The obtained spectrograms e(fⱼ) may be defined for a number of bands f₁, f₂ . . . f_{C}, for example, for C=80 bands or C=128 bands, or any other number of bands. In some embodiments, the bands may be mel-bands and the spectrograms may be mel-spectrograms. Separate spectrograms 222 may be obtained for separate audio frames 212.

In some embodiments, spectrograms 222 may be processed by ASR model 120 (or multiple ASR models). For example, ASR model 120 may process a time sequence of audio data (e.g., mel-spectrograms of a particular speech episode) and generate likelihoods (e.g., probabilities p; or log-probabilities log pⱼ) of various speech units 230 of a language being pronounced within consecutive intervals of a set duration t (e.g., 0.25 sec, 0.5 sec, and/or the like). The generated likelihoods may be used by target-word spotter 124 to detect—represented in speech units 230—one of the target words, e.g., specified in a context-biasing list of words associated with a particular type of audio data 204, e.g., a list of words that can be used in a conference of crypto currency researchers or a meeting of gastroenterologists. Additionally, e.g., as may be performed parallel, the same speech units 230 and the associated likelihoods may be processed by a dictionary word prediction 240, which may be agnostic to the existence of the list of target words. The resulting likelihoods obtained for specific times T for which target-word spotter 122 identifies possible presence of a target word(s) may be processed by a final word selector 250. For example, final word selector 250 may compare a likelihood score S_{WS} (generated by target-word spotter 122) that the word “NVIDIA” was spoken between 1:45.0 seconds and 1:45.9 seconds into audio data 204 to a likelihood score Spic (generated by dictionary word prediction 240) that the word “video” was spoken at the same time and may select the candidate word with the higher scores as the recognized word 252 for that time. In those instances where target-word spotter 122 detects no likelihood of a target word being uttered (or a likelihood that is below an empirically set minimum threshold), the most likely word determined by a dictionary word prediction 240 may be accepted as the recognized word 252.

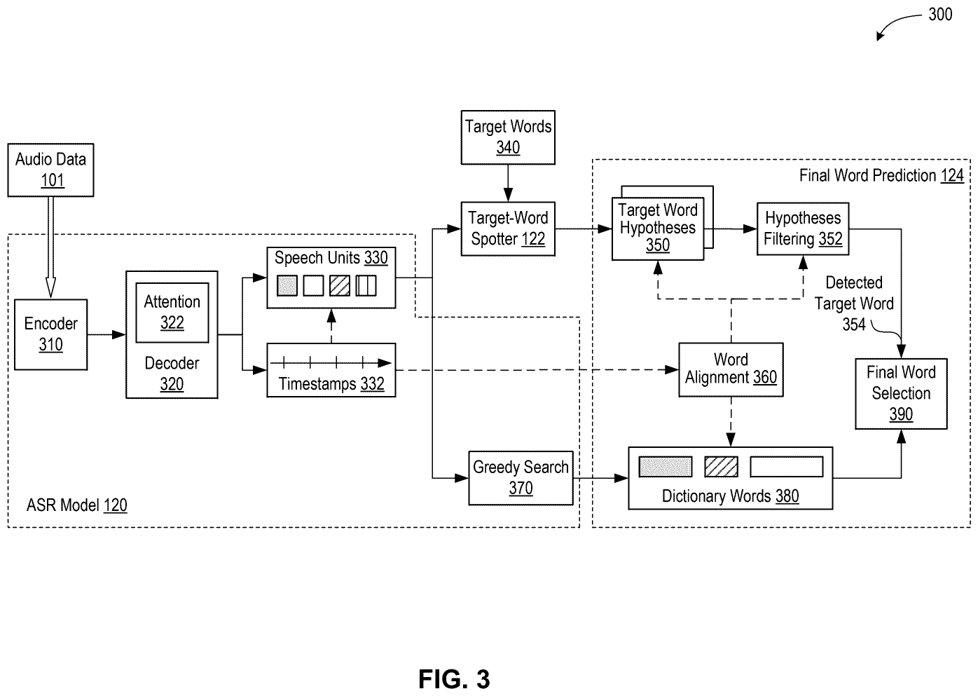

FIG. 3 illustrates one example embodiment 300 of automatic speech recognition processing that combines a general search for dictionary words with a search for target words, according to at least one embodiment. As illustrated, operations of example embodiment 300 may include processing of input audio data 101 (which may be suitably preprocessed, segmented, represented via spectrograms, and/or the like, as described in conjunction with FIG. 2) using an ASR model 120, which may include an encoder 310 and a decoder 320. Encoder 310 may process a suitable portion of audio data 101, e.g., mel-spectrograms of a certain duration (e.g., several seconds or more), to generate feature vectors (embeddings) representative of sound content of audio data 101 in an embedding space of a dimension N (a number of components of an individual feature vector), which may be set as part of training of ASR model 120. Feature vectors may have integer value or floating-point values. Feature vectors may be considered as points in the N-dimensional embedding space. During training, encoder 310 may learn to associate similar sets of training audio data with similar feature vectors corresponding to points closely situated in the embedding space and further learn to associate dissimilar sets of training audio data with points that are located farther apart in the embedding space.

Input into encoder 310 may include multiple layers of convolution filters (kernels) trained to capture an expanding field of view of the spectrograms while simultaneously increasing the feature space dimension. In some embodiments, convolutions may be factorized into depthwise convolutions and pointwise convolutions. In some embodiments, encoder 310 may deploy one or more fully connected layers, one or more residual connections, one or more attention blocks, one or more squeeze-and-excitation blocks and/or the like. Encoder 310 may generate individual feature vectors FV(τ₁), FV(τ₁), . . . , for various individual time intervals τ₁, τ₂, . . . , of a predetermined (e.g., during training of encoder 310) duration t.

Feature vectors FV(τⱼ) generated by encoder 310 may be processed by decoder 320. Decoder 320 may identify likelihoods (e.g., probabilities pⱼ, log-probabilities Lⱼ=log pⱼ, and/or the like) that various speech units 330 are spoken within respective intervals t, of a set duration t, which may be identified with suitable time information output of decoder 320, e.g., timestamps 332. In some embodiments, decoder 320 may be an attention-based decoder that predicts likelihoods of various speech units SU(τⱼ) as a function of the set of all input feature vectors {FV(τₖ)} and earlier-identified speech units SU(τ₁), SU(τ₂), . . . SU(τⱼ₋₁). The attention mechanism 322 allows decoder 320 to identify and take advantage of correlations between different parts of the input sequence when predicting each speech unit SU(τⱼ). Although for brevity and conciseness, speech units are denoted with SU(τⱼ), it should be understood that any, some or all SU(τⱼ) may include likelihoods of multiple alternative speech units being uttered during time intervals τⱼ, e.g., speech unit “n” uttered with probability 0.5, speech unit “m” uttered with probability 0.35, speech unit “d” uttered with probability 0.1, speech unit “t” uttered with probability 0.05, and so on. In some embodiments, e.g., in which ASR model 120 deploys Connectionist Temporal Classification (CTC), decoder 320 may be absent while encoder 310 may generate independent likelihoods for various speech units 330.

The types of speech units 330 generated by ASR model 120 may be determined by a tokenizer deployed as part of an architecture of the model and may include graphemes, subwords, phonemes, and/or any other suitable units of speech that uniquely identify spoken utterances or parts of utterances. In one example, ASR model 120 may deploy a byte-pair encoding (BPE) tokenizer.

Speech units 330 (and the corresponding likelihoods) may be provided to target-word spotter 122 that is on the lookout for an onset of utterance of one of target words 340. Target words 340 (context-biasing list) may be specific to a particular field of knowledge associated with audio data 101.

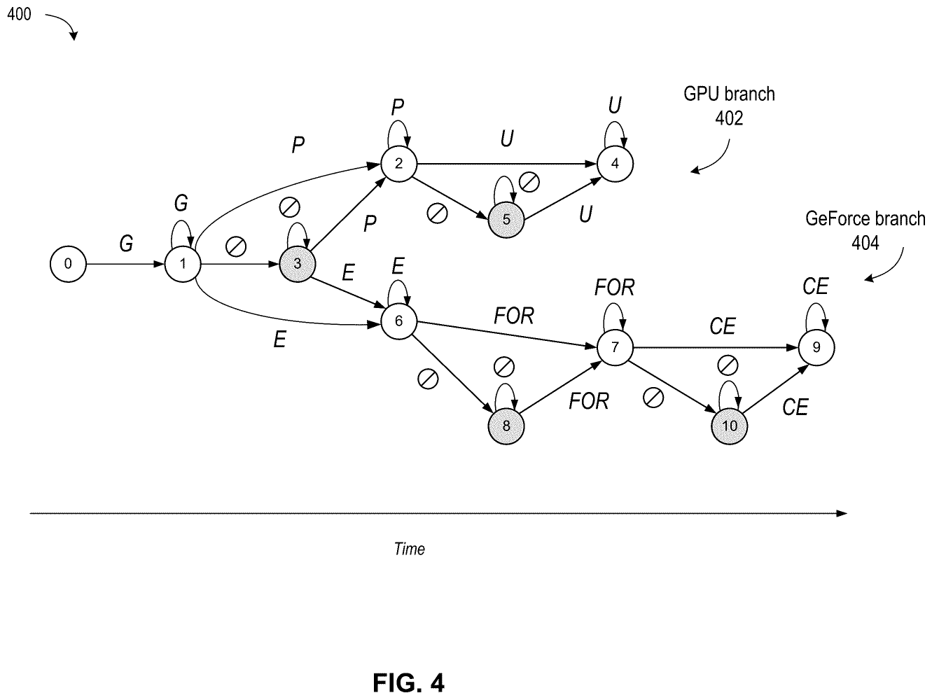

In some embodiments, target words 340 from the context list may be encoded as a context graph (trie). FIG. 4 illustrates an example context graph 400 that may be used for detection of target words for improved accuracy of automatic speech recognition, according to at least one embodiment. As illustrated, context graph 400 may include multiple branches corresponding to sequences of units of respective target words. Two branches—a GPU branch 402 and a GeForce branch 404 corresponding to the respective target words “GPU” and “GeForce” are shown in FIG. 4. Root nodes of the context graph—e.g., root node 0 in FIG. 4 may be associated with starting units of one or more target words. Context graph 400 may also have blank nodes (e.g., nodes 3, 5, 8, and 10 in FIG. 4) to modulate an empty unit according to a suitable transition topology, including but not limited to connectionist temporal classification (CTC) transition rules.

In one example, the list of target words 340 (with continuing reference to FIG. 3) may include “GPU,” “NVIDIA,” “GeForce,” “CUDA,” and/or the like. Target-word spotter 122 may access probabilities (generated by ASR model 120) that speech units “G,” “N,” and “C” (corresponding to the beginnings of the target words) are detected at a particular time interval τ₁ and eliminate from consideration such units whose likelihoods are low. In one example embodiment, a hypothesis (about a possible speech unit) with the highest likelihood Lₘₐₓ may be identified and a difference between Lₘₐₓ and a certain (empirically set) threshold likelihood L₀ may be computed to obtain a minimum likelihood Lₘᵢₙ=Lₘₐₓ−L₀. Target-word spotter 122 may then evaluate the remaining candidate speech units and discard those candidates whose likelihood is below Lₘᵢₙ. For example, target word spotter 122 may retrieve likelihoods of (generated by ASR 120) that speech units 330 “G,” “N,” and “C” are being spoken at time interval τ₁ and determine that the likelihoods of units “N” and “C” are below the minimum likelihood. Correspondingly, target-word spotter 122 may assume that the words CUDA″ are not being uttered (at time interval τ₁), while still considering one or more hypotheses that one of the words “GPU” or “GeForce” is spoken.

After detected speech unit “G,” e.g., at node 0 of context graph 400, as shown in FIG. 4, target-word spotter 122 may initialize processing along the branches associated with the units “G-P-U” and “G-E-F-O-R-C-E” (in the instances of a grapheme-based tokenizer) or “G-E-FOR-CE,” (in the instances of a subword-based tokenizer) where each letter or a combination of letters indicate a node of the graph and each hyphen stands for an edge connecting the nodes. As illustrated, the branches may diverge after speech unit “G.” Target-word spotter 122 may make subsequent steps along the graph based on the likelihoods of speech units 330 generated by ASR model 120 for time intervals τ₂, τ₃, etc. For example, for time interval τ₂, ASR model 120 may have determined that unit “P” is being spoken with likelihood L_{P} and unit “E” is being spoken with likelihood L_{E}. Additionally, ASR model 120 may have determined likelihoods that various other speech units are being pronounced during interval 12, which may indicate that some other word (a dictionary word or another target word) is being spoken. The target-word search may also evaluate a likelihood that pronunciation of unit “P” has continued into interval τ₂ or that a pause (no detectable unit) has occurred, in which instances target-word spotter 122 may dwell on the last node(s) of the graph. For example, at node 3, target-word spotter 122 may determine that the likelihoods of various speech units uttered is below a predetermined minimum value. Target-word spotter 122 may then dwell on node 3 at time interval τ₂ and obtain a likelihood of additional speech units spoken during subsequent time intervals τ₃, τ₄, etc. Likewise, having identified speech units G-P, target-word spotter 122 may determine, at node 2 that no speech unit is being uttered and move to node 5 associated with a blank unit (or, having been moved to node 5 previously, may dwell on node 5 for an extra time interval t). In some instances, target-word spotter 122 may determine that the pronunciation of a previously detected speech unit may continue for one or more additional time intervals and dwell on the corresponding node. For example, if pronunciation of speech unit “E” is detected to continue for an additional time unit, target-word spotter 122 may dwell on node 6. If no speech unit consistent with moving along any of the available branches of context graph 400 is detected for a predetermined number of time intervals, further processing along context graph 400 may be discontinued.

In some embodiments, a single working hypothesis, e.g., the highest likelihood hypotheses, may be maintained at each time interval. For example, if at node 0 and time interval τ₂ the likelihood of unit “P” being spoken is higher than the likelihood of unit “E”, target-word spotter 122 may follow the “G-P-U” branch of the graph and abandon the “G-E-FOR-CE” branch. In some embodiments, multiple working hypotheses may be maintained. In the above example, both branches may be followed until one or more additional speech units are encountered and the likelihood of one of the branches drops below a minimum likelihood.

In some embodiments, transitions to the next non-blank node of context graph 400 may be given additional weights in comparison with dwelling on a last node of the graph (repeated speech unit) or detecting a blank (no detected unit). This enhances the likelihood of detecting target words. Such additional weights may be empirically selected, based on experimentally determined degrees to which recognition of target words is to be favored over detection of dictionary words (or detection of non-speech time intervals).

At the end of context graph 400 processing, target-word spotter 122 may return a score S_{WS} for the most likely word spoken within a time T that spans the series of time intervals T={τ₁ . . . τ_{N}} for the processing of the respective selected branch of the graph. The score S_{WS} may be a multiplication product Πⱼ₌₁^{N}pⱼ of various speech unit probabilities or a sum of log-probabilities Σⱼ₌₁^{N}Lⱼ, which may be further modified with additional weights given to transitions between non-blank nodes of the graph.

Referring again to FIG. 3, in some instances target-word spotter 122 may detect multiple target word hypotheses 350 identifying different candidate target words spoken within the same time or overlapping times, as identified by word alignment 360. In such instances, hypotheses filtering 352 may be performed, e.g., by selecting a candidate word with the maximum score S_{WS}, e.g., as indicated in line 24 of an example CTC-based target-word spotting algorithm of Table 1.

TABLE 1
Example algorithm of a target-word spotter
Algorithm CTC-based Target-Word Spotter

Require: Context graph CG, CTC logprobs L = {L₀, L₁, . . . , L_{T-1}},
blank threshold βₜₕᵣ, non-blank threshold γₜₕᵣ, context-biasing
weight c_{bw}, ctc alignment weight ctc_{w}, beam threshold beamₜₕᵣ,
HYP - hypotheses class with current CG state, accumulated score,
start/end time frames.

| 1: | A = { } | | [symbol] list of active hyps | |
|---|---|---|---|---|
| 2: | C = { } | | [symbol] list of current hyps | |
| 3: | SH = { } | | [symbol] list of spotted hyps | |
| 4: | for t = 0 to T − 1 do | | | |
| 5: | | Add HYP(state = CG.root, start_frame = t) in A | | |
| 6: | | for hyp in A do | | |
| 7: | | | if hyp is empty and lₜ [blank] > βₜₕᵣ then | |
| 8: | | | | continue |
| 9: | | end if | | |
| 10: | | for token in hyp.state.next_tokens do | | |
| 11: | | | if hyp is empty and lₜ [token] < γₜₕᵣ then | |
| 12: | | | | continue |
| 13: | | | end if | |
| 14: | | | new_hyp = HYP(state = hyp.state) | |
| 15: | | | new_hyp.start_frame = hyp.start_frame | |
| 16: | | | new hyp.score = hyp.score + lₜ [token] + c_{bw} | |
| 17: | | | if new_hyp_.tate.is_end_of_word then | |
| 18: | | | | new_hyp.end_frame = t |
| 19: | | | | Add new_hyp in SH |

| | |
|---|---|
| 20: | end if |
| 21: | Add new_hyp in B |

| | |
|---|---|
| 22: | end for |

| | |
|---|---|
| 23: | end for |
| 24: | A = beam_and_state_prunings(C, beamₜₕᵣ) |
| 25: | C = { } |
| 26: | end for |
| 27: | best_cb_candidats = find_best_hyps(SH) |
| 28: | ctc_word_ali = get_ctc_word alignment (L, ctc_{w}) |
| 29: | return merge(ctc_word_ali, best_cb_candidats) |

A final word selection 390 may select from the candidate target word 354 having the maximum score S_{WS} and a maximum-likelihood dictionary word 380 spoken during the same time T (as identified using word alignment 360). The dictionary word may be determined using a general (dictionary) word search, such as a greedy search, e.g., implemented using an CTC-greedy algorithm.

A higher-score word may then be selected as the final recognized word. For example, if target-word spotter 122 determines that the word “NVIDIA” has score S_{WS}=−3.6 (the sum of log-probabilities of the speech units of the word) and greedy search 370 has determined that the word “video” has score S_{CTC}=−5.2, the word “NVIDIA” may be selected as the final recognized word. In some embodiments, one or more additional decoders may be available, which may output separate predictions of spoken words. In some instances, such decoders (e.g., RNNT decoder) may be more accurate than the decoder that outputs individual speech unit probabilities (e.g., the CTC decoder). In such instances, a word identified using a comparison of S_{CTC} and S_{WS} scores may replace a word (or multiple words) predicted for the corresponding time T by a more accurate decoder. For other times, where no target word was predicted by the target-word spotter, the words predicted by the more accurate decoder may be selected as the final predicted words.

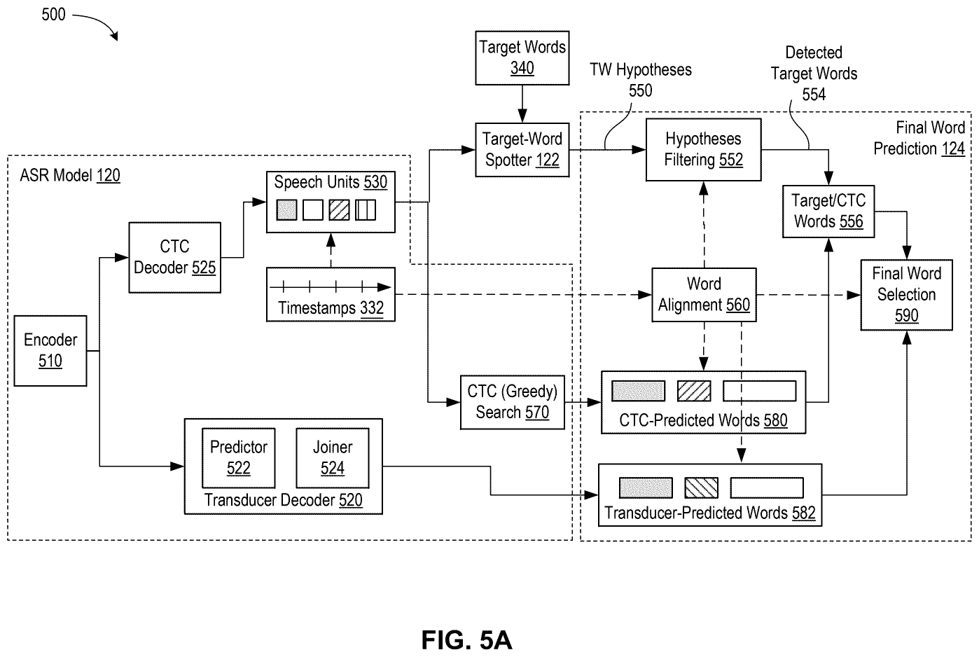

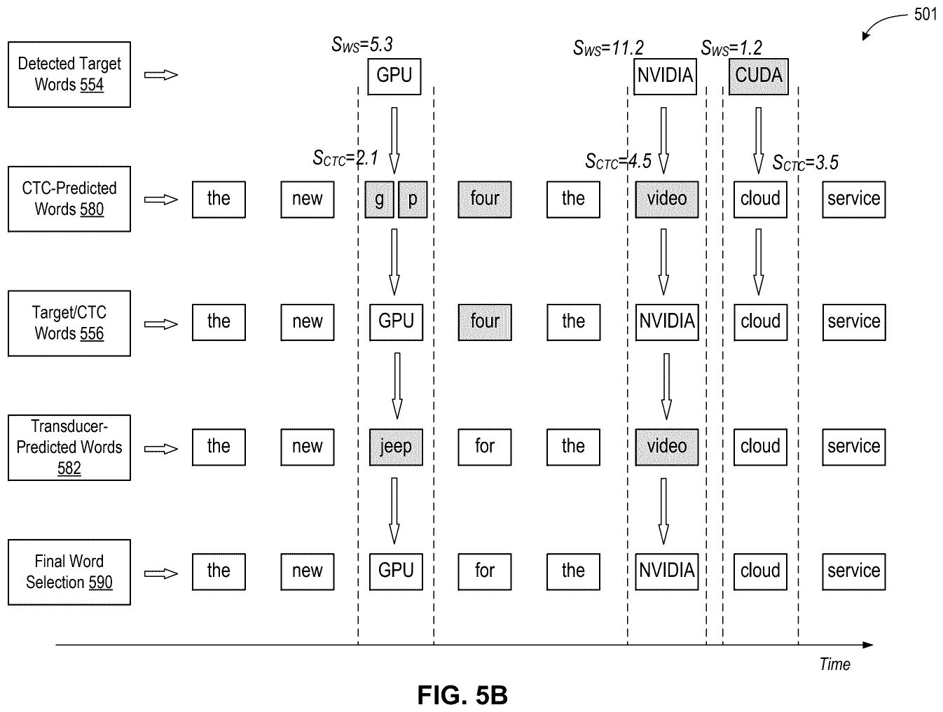

FIG. 5A illustrates one example embodiment 500 of automatic speech recognition that deploys a hybrid transducer-CTC model augmented with a search for target words, according to at least one embodiment. As illustrated, encoder 510 may output feature vectors to both a CTC decoder 525 and a separate transducer decoder 520. CTC decoder 525 may convert individual feature vectors into independent likelihoods of various speech units 530, FV(τⱼ)→SU(τⱼ). The transducer decoder 520 may, on the other hand, have a more sophisticated architecture (e.g., RNNT architecture) that includes a predictor network 522 and a joiner network 524. Predictor network 522 may be (or include) an autoregressive network whose input (encoder output) is augmented by the previously identified speech units SU(τ₁), SU(τ₂), . . . . SU(τⱼ₋₁). Predictor network 522 then produces additional features G(τⱼ) that are used, as input, into joiner network 524 together with features FV(τⱼ) generated by encoder 510. The output of transducer decoder 520 may be a set of transducer-predicted words 582.

The outputs of CTC decoder 525 may include speech units 530, which may be similar to speech units 330 of FIG. 3. Speech units 530 may be used by target-word spotter 122 that generates target-word (TW) hypotheses 550 and performs hypotheses filtering 552, e.g., substantially (or in a similar fashion) as disclosed in conjunction with FIG. 3, including using word alignment 560 with timestamps generated by ASR model 120. The detected target word 554 may have the highest score S_{WS} of various TW hypotheses 550. The score S_{WS} may be compared with the score S_{CTC} of the CTC-predicted (e.g., dictionary) word 580 for the same time T. A word with the higher score (S_{WS} or S_{CTC}) may then be selected as a target/CTC word 556.

Since a transducer decoder 520 may be more accurate than decoders that output individual speech unit probabilities (e.g., CTC decoder 525), a final word selection 590 may ordinarily give preference to the transducer-predicted words 582, e.g., in the instances when there is no competing target/CTC word 556 identified using the target-word spotter 122. On the other hand, at those times T where a target/CTC word 556 has been identified, final word selection 590 may replace a transducer-predicted word 582 (or multiple words) with the target/CTC word 556 obtained for the corresponding time T.

FIG. 5B illustrates schematically an example processing 501 of a spoken utterance using a hybrid ASR model architecture of FIG. 5A, according to at least one embodiment. FIG. 5B depicts recognition of the utterance “the new GPU for the NVIDIA cloud service.” Words correctly identified during various stages of processing are shown in white boxes and words identified incorrectly are shown in shaded boxes. As illustrated, FIG. 5B depicts detected target words 554, e.g., the highest likelihood target-word spotter hypotheses predicted for the respective times. In particular, words “GPU,” “NVIDIA,” and “CUDA” are identified for some of the times of the spoken utterance. For other times, target-word spotter does not identify any target words and may, therefore, return no outputs (or null outputs). FIG. 5B further depicts CTC-predicted words 580 with incorrectly predicted words “four,” “video,” and single-character sounds “g” and “p.” Detected target words 554 and CTC-predicted words 580 may be associated with respective scores S_{WS} and S_{CTC}. Comparison of S_{WS} and S_{CTC} for individual words may be used to select target/CTC words 556 from detected target words 554 and CTC-predicted words 580. (Although, for the case of viewing, the scores are shown as positive numbers, in some embodiments, the scores may be negative, e.g., computed as sums of negative log-probabilities.) As illustrated, word “GPU” may be selected over “g” and “p,” word “NVIDIA” may be selected over word “video,” and word “cloud” may be selected over word “CUDA.” Those target/CTC words 556 that were determined using the input from the target-word spotter—namely, words “GPU,” “NVIDIA,” and “cloud”—are then used to replace the transducer-predicted words 582 predicted by the transducer decoder for the same times. In this example, the word “GPU” replaces the word “jeep” and the word “NVIDIA” replaces the word “video” (with the word “cloud” being the same in the two sets of predictions).

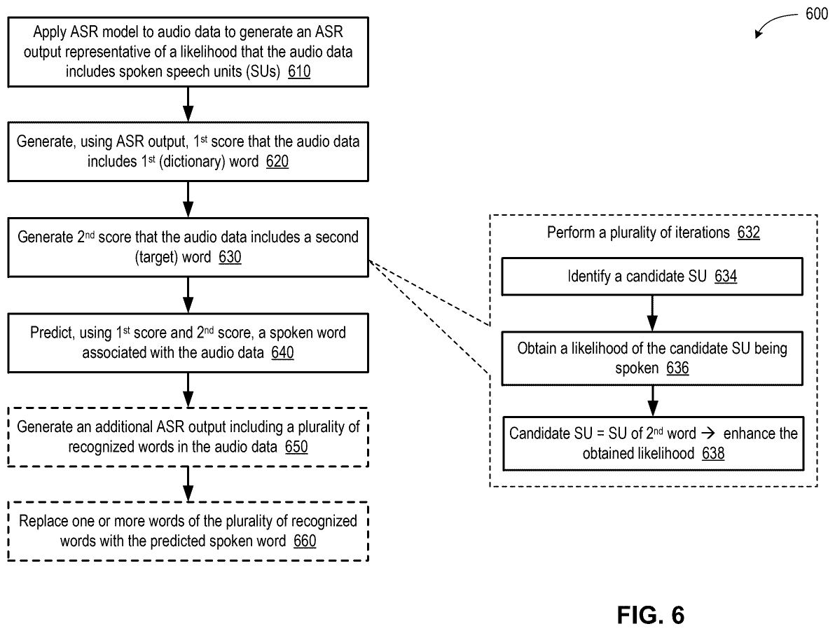

FIG. 6 is a flow diagram of a method 600 of automatic speech recognition that combines a general search for dictionary words with a search for target words, according to at least one embodiment, according to at least one embodiment. Method 600 may be performed using one or more processing units (e.g., CPUs, GPUs, accelerators, PPUs, DPUs, etc.), which may include (or communicate with) one or more memory devices. In at least one embodiment, method 600 may be performed using processing units of audio processing server 102. In at least one embodiment, processing units performing method 600 may be executing instructions stored on non-transient computer-readable storage media. In at least one embodiment, method 600 may be performed using multiple processing threads (e.g., CPU threads and/or GPU threads), individual threads executing one or more individual functions, routines, subroutines, or operations of the method. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of method 600 may be performed concurrently with other operations. In at least one embodiment, one or more operations shown in FIG. 6 may not always be performed.

Method 600 may involve speech utterances produced by people in any possible context, e.g., a conversation, a public speech, a public event, a business meeting, a conference, a street encounter, an interaction in a game, an interaction with a chat bot or a digital avatar, an interaction with an in-vehicle infotainment system, and/or the like. “Speech,” as used in the context of method 600 should be understood as also including sounds of non-human origins, e.g., sounds of animals. “Speech,” as used in the context of method 600 should also be understood as including sounds produced by non-living entities, including natural forces, such as wind, sea, ocean, thunderstorms, and various other atmospheric or naval phenomena, as well as robotic speech, synthesized or computer-generated speech, and so on. One or more operations of method 600 may be performed by audio processing server 102 of FIG. 1 and/or FIG. 2.

At block 610, method 600 may include applying an automatic speech recognition model (e.g., ASR 120 in FIG. 3 or FIG. 5) to audio data (e.g., audio data 101) to generate an ASR output. The ASR output may be representative of a likelihood that the audio data includes one or more spoken speech units (SUs). In some embodiments, the ASR output may include, for one or more time intervals (e.g., τ₁ . . . τ_{N}) of the audio data, a plurality of SU likelihoods, e.g., probabilities pⱼ, log-probabilities Lⱼ, and/or any other suitable likelihoods that a respective SU of a plurality of SUs was spoken during a respective time interval.

At block 620, method 600 may include generating, using the ASR output, a first score (e.g., S_{CTC}) characterizing a likelihood that the audio data includes a first word, which may be a dictionary word, or any other word that the ASR encountered multiple times during training. In some embodiments, the first score may be generated using greedy search 370 of FIG. 3 and/or CTC search 570 of FIG. 5. At block 630, method 600 may include generating, using the ASR output, a second score (e.g., S_{WS}) characterizing a likelihood that the audio data includes a second word, e.g., one of a plurality of target words. The plurality of target words may be identified based on a context of the audio data, but may also include neologisms, abbreviations, and/or the like. In some embodiments, the second score may be generated using target-word spotter 122.

In some embodiments, generating the second score may include performing a plurality of iterations identified by a context graph (e.g., as illustrated in FIG. 4). The context graph may be associated with the plurality of target words and may include one or more root nodes associated with a starting SU of various target words.

In some embodiments, generating the second score may include generating multiple hypotheses. An individual hypothesis may associate a portion of the audio data with a respective hypothesized word of the plurality of target words and may assign, based on the ASR, a score to the respective hypothesized word. The assigned score may characterize a likelihood that the portion of the audio data includes the respective hypothesized word. Correspondingly, each of the hypotheses may be characterized by a different score S_{WS}. The hypothesized words may be time-overlapping (e.g., such that the hypotheses are mutually exclusive). The second word may then be identified, using the assigned scores S_{WS}, as the most likely word captured by the portion of the audio data.

In some embodiments, generating the second score may include operations illustrated in the callout portion 632 of FIG. 6, which may be performed via a plurality of iterations. An individual iteration of the plurality of iterations may be associated with a respective time interval (e.g., τⱼ) of the plurality of time intervals (e.g., τ₁ . . . τ_{N}) of the audio data and may include selecting, using the ASR output, from several possibilities, which may include selecting an SU of the second word (the SU spoken during the respective time interval τⱼ), dwelling on a previously detected SU, or detecting a state of no SU being spoken during the respective time interval.

In some embodiments, the SU of the second word may be selected responsive to a likelihood of the SU being spoken exceeding a threshold likelihood and also exceeding the (ii) likelihoods of other SUs being spoken during the same time interval. In some embodiments, the state of no SU being spoken may be selected responsive to no SU of the second word having a likelihood of being spoken above a threshold likelihood.

In some embodiments, selection of the SU or the state of no SU may include identifying a candidate SU (block 634), obtaining, using the ASR output, a likelihood of the candidate SU being spoken during the respective time interval (block 636), and may further include, responsive to determining that the candidate SU matches the SU of the second word, enhancing the obtained likelihood of the candidate SU (block 638). For example, enhancing the obtained likelihood may be performed by adding a predetermined weight (boost) to the likelihood of the candidate SU.

At block 640, method 600 may include predicting, using the first score and the second score, a spoken word associated with the audio data, e.g., by selecting, from the first word and the second word, the word associated with the higher score.

In some embodiments, as illustrated with block 650, the ASR model may further generate an additional ASR output that includes a plurality of recognized words (e.g., transducer-predicted words 582 in FIG. 5A) in the audio data. In some embodiments, the ASR model may include an encoder (e.g., encoder 510) and a plurality of decoders. For example, a first decoder may be or include a connectionist temporal classification (CTC) decoder (e.g., CTC decoder 525), and the second decoder may be or include an RNNT decoder (e.g., transducer decoder 520). In such embodiments, the ASR output (e.g., speech units 530 and the corresponding likelihoods, CTC-predicted words 580, and/or the like) may be generated using the first decoder and the additional ASR output may be generated using the second decoder.

At block 660, method 600 may include replacing one or more words of the plurality of recognized words (e.g., transducer-predicted words 582) with the predicted (e.g., using target-word spotter) spoken word (e.g., as illustrated in FIG. 5B).

The systems and methods described herein may be used for a variety of purposes, by way of example and without limitation, for performing one or more operations with respect to machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Inference and Training Logic

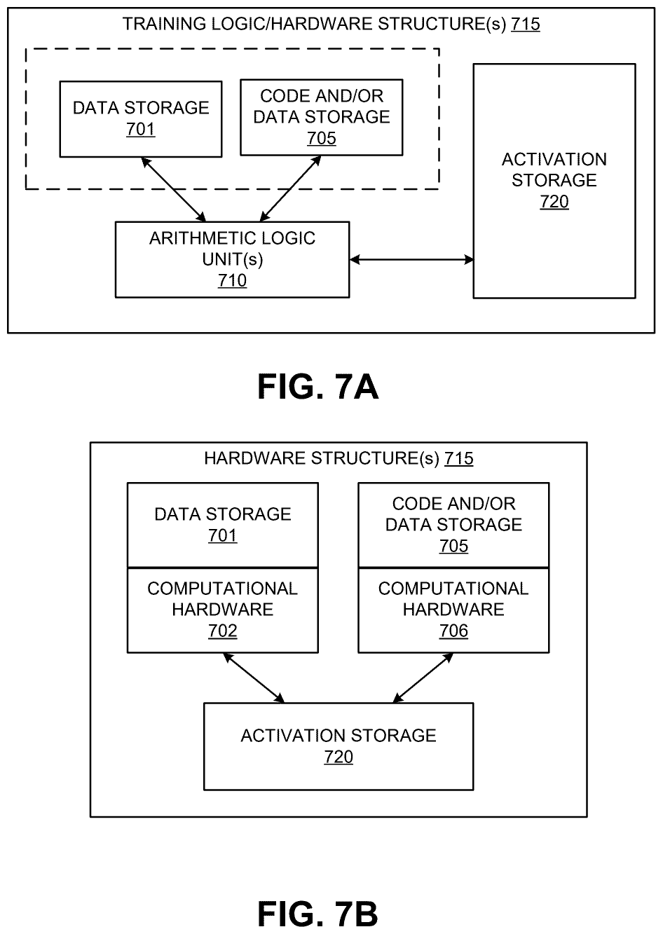

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

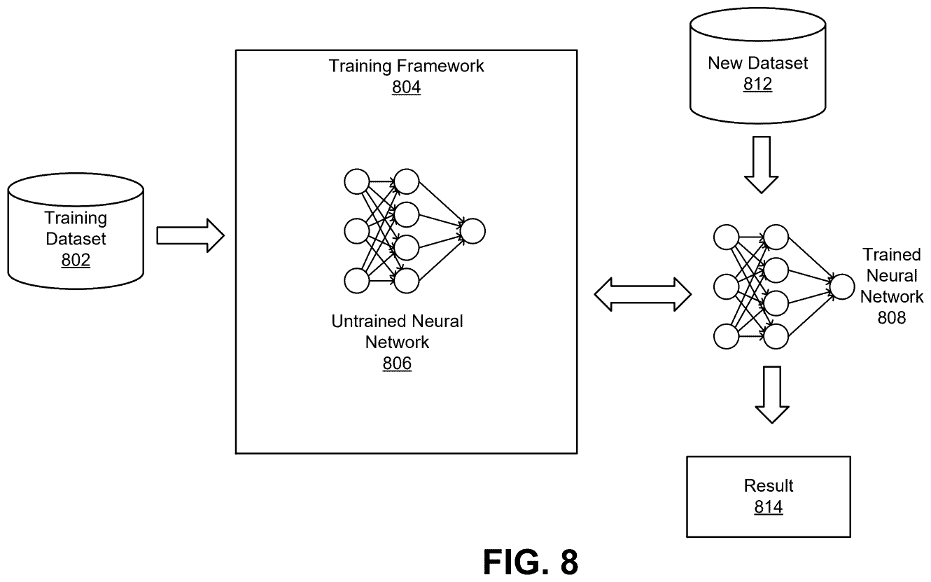

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

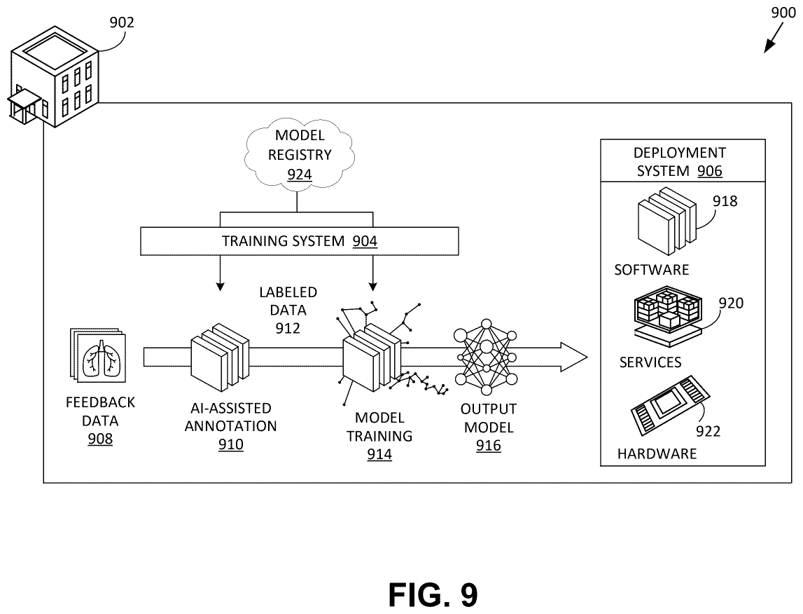

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

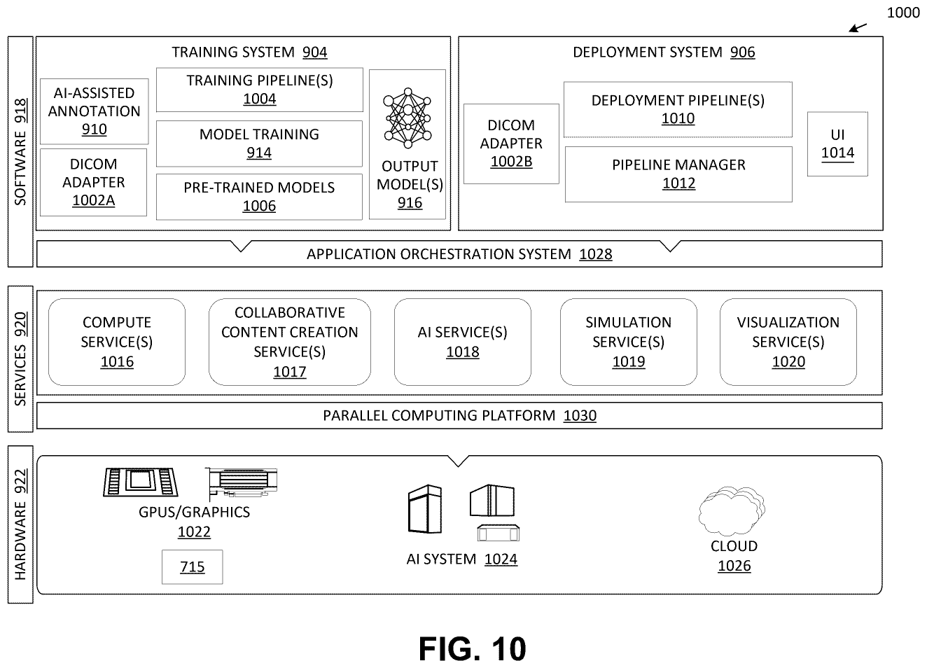

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
applying an automatic speech recognition (ASR) model to audio data to generate an ASR output representative of a likelihood that the audio data comprises one or more spoken speech units (SUs);
generating, using the ASR output, a first score characterizing a likelihood that the audio data comprises a first word included in a dictionary;
generating, using the ASR output, a second score characterizing a likelihood that the audio data comprises a second word, the second word including a word from a plurality of target words that are identified based at least on a context of the audio data; and
predicting, using the first score and the second score, a spoken word associated with the audio data.

2. The method of claim 1, wherein the ASR output comprises, for one or more time intervals of the audio data:
a plurality of SU likelihoods, wherein an individual SU likelihood of the plurality of SU likelihoods characterizes a probability that a respective SU of a plurality of SUs was spoken during a respective time interval.

3. The method of claim 1, wherein the generating the second score comprises:
generating a plurality of hypotheses, wherein an individual hypothesis of the plurality of hypotheses:
associates a portion of the audio data with a respective hypothesized word of the plurality of target words, and
assigns, based at least on the ASR output, a score to the respective hypothesized word, wherein the assigned score characterizes a likelihood that the portion of the audio data comprises the respective hypothesized word; and
identifying, using the assigned scores, the second word as a most likely word represented in the portion of the audio data.

4. The method of claim 3, wherein the hypothesized words are time-overlapping.

5. The method of claim 1, wherein the generating the second score comprises performing a plurality of iterations, wherein an individual iteration of the plurality of iterations is associated with a respective time interval of a plurality of time intervals of the audio data, and wherein the individual iteration comprises:
for a respective time interval of the plurality of time intervals, selecting, using the ASR output, from at least:
an SU of the second word, the SU being spoken during the respective time interval, or
a state of no SU being spoken during the respective time interval.

6. The method of claim 5, wherein the SU of the second word is selected responsive to:
a likelihood of the SU being spoken exceeding (i) a threshold likelihood and (ii) likelihoods of one or more other SUs being spoken during the respective time interval.

7. The method of claim 5, wherein the state of no SU being spoken is selected responsive to no SU of the second word having a likelihood of being spoken above a threshold likelihood.

8. The method of claim 5, wherein the selecting from the at least the SU of the second word or the state of no SU comprises:
identifying a candidate SU;
obtaining, using the ASR output, a likelihood of the candidate SU being spoken during the respective time interval; and
responsive to determining that the candidate SU matches the SU of the second word, enhancing the obtained likelihood of the candidate SU.

9. The method of claim 1, wherein the generating the second score comprises:
performing a plurality of iterations identified by a context graph associated with the plurality of target words, wherein the context graph comprises one or more root nodes associated with a starting SU of one or more target words of the plurality of target words.

10. The method of claim 1, wherein the ASR model is further to generate an additional ASR output comprising a plurality of recognized words in the audio data.

11. The method of claim 10, further comprising:
replacing one or more words of the plurality of recognized words with the predicted spoken word.

12. The method of claim 10, wherein the ASR model comprises an encoder and a plurality of decoders, wherein the ASR output is generated using a first decoder of the plurality of decoders, and wherein the additional ASR output is generated using a second decoder.

13. The method of claim 12, wherein the first decoder comprises a connectionist temporal classification (CTC) decoder, and wherein the second decoder comprises a recurrent neural network transducer (RNNT) decoder.

14. A system comprising:
one or more processors to:
apply a machine learning model (MLM) to audio data to generate an MLM output representative of a likelihood that the audio data comprises one or more spoken speech units (SUs);
determine, using the MLM output, a first score characterizing a likelihood that the audio data comprises a first word included in a dictionary;
determine, using the MLM output, a second score characterizing a likelihood that the audio data comprises a second word from a plurality of target words that are identified based at least on a context of the audio data; and
predict, using the first score and the second score, a spoken word associated with the audio data.

15. The system of claim 14, wherein to determine the second score, the one or more processors are to:
generate a plurality of hypotheses, wherein an individual hypothesis of the plurality of hypotheses:
associates a portion of the audio data with a respective hypothesized word of the plurality of target words, and
assigns, based at least on the MLM output, a score to the respective hypothesized word, wherein the assigned score characterizes a likelihood that the portion of the audio data comprises the respective hypothesized word; and
identify, using the assigned scores, the second word as a most likely word represented by the portion of the audio data, wherein the hypothesized words are time-overlapping.

16. The system of claim 14, wherein to determine the second score, the one or more processors are to perform a plurality of iterations, wherein an individual iteration of the plurality of iterations is associated with a respective time interval of a plurality of time intervals of the audio data, and wherein to perform an individual iteration, the one or more processors are to:
for a respective time interval of the plurality of time intervals, select, using the MLM output, from at least:
an SU of the second word, the SU being spoken during the respective time interval, or
a state of no SU being spoken during the respective time interval.

17. The system of claim 16, wherein the SU of the second word is being selected responsive to:
a likelihood of the SU being spoken exceeding (i) a threshold likelihood and (ii) likelihoods of one or more other SUs being spoken during the respective time interval.

18. The system of claim 16, wherein to select from the at least the SU of the second word or the state of no SU, the one or more processing units are to:
identify a candidate SU;
obtain, using the MLM output, a likelihood of the candidate SU being spoken during the respective time interval; and
responsive to determining that the candidate SU matches the SU of the second word, enhance the obtained likelihood of the candidate SU.

19. The system of claim 14, wherein the system is comprised in at least one of:
an in-vehicle infotainment system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.

20. A processing device comprising processing circuitry to:
predict a spoken word associated with audio data based at least on a first score and a second score computed using an output of one or more neural networks that process the audio data, the first score indicating a likelihood that the spoken word corresponds to a dictionary word and the second score indicating a likelihood that the spoken word corresponds to a target word from one or more target words.
